(19) United States
(12) Patent Application Publication
(10) Pub. No.: US 2023/0343945 A1
(43) Pub. Date: Oct. 26, 2023

(54) Electrochemical Cells

(71) Applicant: IFBattery Inc., West Lafayette, IN (US)

(72) Inventors: Eric A. Nauman, Cincinnati, OH (US); Michael J. Dziekan, Park Ridge, IL (US)

(21) Appl. No.: 17/800,607

(22) PCT Filed: Feb. 19, 2021
(86) PCT No.: PCT/US2021/018766

§ 371 Date: Aug. 18, 2022

Related U.S. Application Data
(60) Provisional application No. 62/978,921, filed on Feb. 20, 2020.

(51) Int. Cl. H01M 4/46; H01M 4/66; H01M 10/36; H01M 10/39

(52) U.S. Cl. CPC H01M 4/463; H01M 4/663; H01M 10/36; H01M 10/399; H01M 2004/027

(57) ABSTRACT

Cells for use in electrochemical devices as well as electrochemical cells and their use in producing electricity, hydrogen, or both electricity and hydrogen simultaneously. The cells include an electrode comprising a liquid phase material, comprising at least one of gallium and indium, disposed on a metal solid comprising aluminum. The liquid phase material can disrupt an oxide layer on the metal solid such that the aluminum can take part in an electrochemical reaction.

### CROSS-REFERENCE TO RELATED APPLICATIONS

This application claims priority to, and benefit of, U.S. Provisional Application No. 62/978,921, filed on Feb. 20, 2020, the entire contents of which is specifically incorporated by reference herein.

### FIELD OF THE DISCLOSURE

This disclosure relates to cells for use in electrochemical devices, electrochemical cells, and use of electrochemical cells for producing electricity, hydrogen, or both electricity and hydrogen simultaneously.

### SUMMARY

The disclosure includes a cell for use in an electrochemical device, which comprises:
an anode comprising:
   (a) a metal solid comprising aluminum, and
   (b) a liquid phase material, comprising at least one of gallium and indium, disposed on the metal solid; and
a cathode, or a cathode current collector, positioned at a distance from the anode.

The liquid phase material (b) disposed on the metal solid comprising aluminum (a) can disrupt an oxide layer on the metal solid such that the aluminum can take part in an electrochemical reaction. Additional embodiments include electrochemical cells and methods of producing electricity, hydrogen, or both electricity and hydrogen with the electrochemical cells.

More embodiments and features are included in the detailed description that follows, and will be readily apparent to those skilled in the art from the description or recognized by practicing the embodiments as described in the description, including in the figures and claims.

### BRIEF DESCRIPTION OF THE DRAWINGS

The accompanying figures constitute a part of this disclosure. The figures serve to provide a further understanding of certain exemplary embodiments. The disclosure and claims are not limited to embodiments illustrated in the figures.

FIG. 1 is a first exemplary design of an electrochemical cell of the disclosure.

FIG. 2 is a second exemplary design of an electrochemical cell of the disclosure.

FIG. 3 is a graph of voltage over time from the aqueous alloy experiment in Example 5.

### DETAILED DESCRIPTION

Various additional embodiments of the disclosure will now be explained in greater detail. Both the foregoing general description and the following detailed description are exemplary and explanatory only, and are not restrictive of this disclosure or of the claims. Any discussion of certain embodiments or features, including those depicted in the figures, serve to illustrate certain exemplary aspects of the disclosure. The disclosure and claims are not limited to the embodiments specifically discussed herein.

An embodiment of the disclosure includes a cell for use in an electrochemical device, which comprises:
an anode comprising:
   (a) a metal solid comprising aluminum, and
   (b) a liquid phase material, comprising at least one of gallium and indium, disposed on the metal solid; and
a cathode, or a cathode current collector, positioned at a distance from the anode.

The term “metal solid” refers to a metal at a temperature below its melting point. Such a solid can exist in a softened or malleable state at certain temperatures and still be considered a “solid” for purposes of this disclosure. The term “liquid phase material” refers to a material at a temperature at or above its melting point. Such a material can exist in a highly viscous state and still be considered a “liquid” for purposes of this disclosure.

The metal solid (a) of the electrode comprises aluminum. The metal solid may further comprise, for example, one or more of magnesium, silicon, iron, copper, chromium, zinc, titanium, gallium, indium and manganese. In some embodiments, the metal solid comprises 95% or more aluminum by weight, or 98% or more aluminum by weight or 99% or more aluminum by weight. One illustrative metal solid is Aluminum Alloy 6061. Another illustrative metal solid is 1000 series Aluminum Alloy. An exemplary metal solid comprises aluminum and, by weight %, 0.0-0.15% magnesium, 0.0-0.8% silicon, 0.0-0.7% iron, 0.0-0.4% copper, 0.0-0.35% chromium, 0.0-0.25% zinc, 0.0-0.25% titanium, 0.0-0.03% gallium, 0.0-0.05% indium and 0.0-0.15% manganese.

The metal solid may have any appropriate form. For example, the metal solid may be in the form of a sheet, rod, bar, block or foil. A sheet is typically flat with opposing top and bottom sides. A sheet could also include a portion that is not flat, such as a portion that is bent to secure or otherwise accommodate positioning the sheet within an electrochemical cell. The thickness of a metal solid sheet can range, for example, from 1 mm to 25.4 mm, including from 1 mm to 5 mm (such as 3.4 mm).

The liquid phase material (b) comprises at least one of gallium and indium. The liquid phase material may further comprise, for example, tin or bismuth. Tin, bismuth or other components may be included, for instance, to influence the melting point of the material.

In some embodiments, the liquid phase material comprises both gallium and indium. Such a material could be referred to as an “alloy” of gallium and indium.

In other embodiments, the liquid phase material comprises gallium but not indium. For example, the liquid phase could comprise essentially pure gallium (e.g., 99%, 99.5%, 99.9% or more by weight of gallium), or may comprise gallium and at least one of tin and bismuth. In further embodiments, the liquid phase material comprises indium but not gallium. For example, the liquid phase could comprise essentially pure indium (e.g., 99%, 99.5%, 99.9% or more by weight of indium), or may comprise indium and at least one of tin and bismuth.

In additional embodiments, the liquid phase material consists of gallium and indium. Such an alloy could consist of, for example, 78% of gallium by weight and 22% of indium by weight. In other embodiments, the liquid alloy consists of gallium, indium and tin, or gallium, indium and bismuth, or gallium, indium, tin and bismuth.

It has been observed that aluminum atoms from the metal solid (a) can diffuse into the liquid phase material (b), which may be advantageous in the supply of aluminum to an electrochemical reaction in the cells of the disclosure. For purposes of this disclosure, any reference to the liquid phase material “consisting of” gallium, indium, or gallium and indium, either alone or together with tin or bismuth, does not exclude such a liquid phase material that may also contain aluminum diffusing from the metal solid. Furthermore, the weight percents of the components of the liquid phase material disclosed herein refer to the weight percents of those components without including the amount of any aluminum from the metal solid that diffuses into the liquid phase material.

The liquid phase material (b) is disposed on the metal solid (a). The liquid may have a thickness that extends above the surface of the metal solid on which it is disposed. In some embodiments, the metal solid is porous to the liquid phase material, wherein at least a portion of the liquid (b) is disposed within the porosity of the metal solid (a). A thickness or layer of liquid above the surface of the metal solid may or may not exist when the metal solid is porous to the liquid. In some embodiments, at least the majority of liquid phase material is disposed within the porosity of the metal solid (a). This could be accomplished, for example, by applying the liquid phase material to the solid, allowing at least a portion of the liquid phase material to diffuse or otherwise penetrate into the porosity of the solid, then removing the liquid phase material from the surface of the solid such as by wiping it off the surface. For purposes of this disclosure, a liquid phase material “disposed on the metal solid” therefore includes embodiments where some, at least a majority, or all, of the liquid phase material is within the porosity of the metal solid. The concentration of the liquid phase material may vary or may be constant throughout the thickness of the metal solid. A liquid phase material “disposed on the metal solid” also includes embodiments where some, at least a majority, or all, of the liquid phase material is present on the surface of the metal solid.

The liquid phase material may be disposed on every surface of the metal solid, or on one entire surface of the metal solid, or on portions of one or more surfaces of the metal solid. In some embodiments where the metal solid is in the form of a sheet, the liquid may be disposed only on a top or bottom side of the sheet. In this instance, the liquid may be disposed, for example, on at least 50%, at least 80%, at least 90% or 100% of the surface area available on the top or bottom surface of the sheet.

The liquid phase material may be disposed on the metal solid using any appropriate technique. Exemplary techniques include pouring, brushing or spraying the liquid onto the metal solid, dipping the metal solid into a volume of the liquid, or otherwise contacting the metal solid with the liquid.

In the event that the metal solid comprising aluminum possesses an oxide layer on the aluminum, a region of the oxide layer could be disrupted before or after applying the liquid phase material to that region. Embodiments of the disclosure therefore include scoring a region of the aluminum, then disposing the liquid phase material on the resulting score marks. Further embodiments of the disclosure include disposing the liquid phase material on the metal solid, then scoring a region of the aluminum beneath the liquid to disrupt the oxide layer.

The cell for use in an electrochemical device further comprises a cathode, or a cathode current collector. The anode should be positioned at a distance from the cathode, or from the cathode current collector. This prevents physical contact between the anode and the cathode, or cathode current collector, within the same cell. The distance between the two can also serve as a conduit for flow of electrolyte solution.

The cathode current collector may be made of any appropriate material. For example, it may comprise one or more of bronze, phosphor bronze, steel, carbon, the graphite allotrope of carbon, carbon impregnated with a metal, carbon foam, copper, tin, iron, lead, platinum, gold and silver.

The cathode may also be made of any appropriate material. For example, it may comprise one or more of bronze, phosphor bronze, steel, copper, tin, iron, lead, platinum, gold and silver.

The cathodes or cathode current collectors in this disclosure may have any appropriate form. For example, they may be in the form of a sheet, rod, bar, block or foil. As with an anode sheet, a cathode current collector or cathode sheet is typically flat with opposing top and bottom sides, but could also include a portion that is not flat. The thickness of a cathode current collector or cathode sheet can range, for example, from 0.05 mm to 0.5 mm, or from 0.1 mm to 0.3 mm, such as 0.28 mm. In other embodiments, the cathode current collector has a thickness up to 2.0 mm, for example, when the cathode current collector is carbon foam.

The anode and the cathode, or cathode current collector, may be maintained at a distance from each other using any appropriate technique. For instance, the two may be separated from each other by non-conductive spacers positioned between them. The term “non-conductive” with reference to the spacer means that the spacer is not electrically conductive. Non-conductive materials include those that are classified as electrical insulators. Thus, any electrical insulator can be used as a spacer. Example non-conductive materials include non-conductive polymers and plastics, glass, paper or cardboard, wood, clay, mica, rubber and Teflon. The thickness of the spacers can be of any appropriate dimension, such as from 0.1 mm to 10.0 mm, including from 0.1 mm to 5 mm, such as 0.8 mm or 2.5 mm. Any appropriate technique other than the use of a spacer could also be used to maintain a distance between the anode and cathode, or cathode current collector, within a cell. This could include any fixtures that hold the components in place at a distance from each other.

In some embodiments, a non-conductive spacer is porous. In this context, a “porous” non-conductive spacer is porous to electrolyte, and is also porous in a non-selective manner to anions and cations in an electrolyte solution contacting the cell. Examples of porous, non-conductive spacers include porous glass, papers, fabrics, cloth, wood, organic polymer (such as vinyl coated polyester), fiberglass film, glass wool, cardboard, nylon, and combinations of two or more of these. In some embodiments, the porous spacer can occupy all or a substantial amount of distance or volume between the anode and cathode current collector of a cell, such as when the cell uses a single electrolyte solution shared between an anode and cathode current collector. In such an embodiment, an electrolyte solution could flow in a tortuous path through the porous material. In other embodiments, the porous spacer does not occupy all or a substantial amount of distance or volume between the anode and cathode current collector. In that embodiment, an electrolyte solution could flow both through and around the porous spacer.

In other embodiments, a non-conductive spacer is non-porous. Examples of non-porous, non-conductive spacers include non-porous plastics, elastomers, organic polymers, gels, rubbers, O-rings, and combinations of two or more of these. Such materials can, for example, separate the cathode current collector and anode of the same cell such that a conduit is formed between the two that can be occupied by an electrolyte solution.

In some embodiments, the cell for use in an electrochemical device does not comprise, and is not contacted with, an electrolyte solution. Such embodiments may, for example, be constructed in one location then transported to another location where they are contacted with electrolyte solution for use as an electrochemical device, such as an electrochemical cell or battery.

A further embodiment of the disclosure includes an electrochemical cell comprising the cell described above and an electrolyte solution.

In some embodiments, the electrochemical cell comprises a cathode current collector positioned at a distance from the anode, wherein the electrolyte solution is a catholyte, comprising an oxidant, and is flowing or otherwise present between the anode and cathode current collector. This electrochemical cell may comprise, for example, a single electrolyte solution that is shared in common between the anode and the cathode current collector. The term “single electrolyte solution” refers to a bulk volume of one electrolyte solution shared in common between an anode and cathode current collector within the same cell. This contrasts with conventional liquid batteries, which require at least two separated electrolyte solutions, i.e., an electrolyte solution for each of the half cells. The single electrolyte solution may comprise any appropriate number of components as described herein, including multiple components that could be considered electrolyte components.

When using a single electrolyte solution, for example, the cathode current collector distributes electrons that reduce oxidant within the electrolyte solution at the surface of the current collector, wherein the electrolyte solution can be characterized as a catholyte. The cathode current collector can be, for example, embedded in or otherwise suitably contacting the catholyte, wherein the catholyte is the source of oxidant for reduction at the cathode current collector.

In some embodiments that include a single electrolyte solution shared between the anode and cathode current collector of a cell, the single electrolyte solution is in physical contact with the liquid phase material (b) of the anode. In this embodiment the electrolyte solution is therefore in contact with both the liquid phase material of the anode and the cathode current collector. In other embodiments, the electrochemical cell comprises a boundary layer disposed between the liquid phase material (b) of the anode and the electrolyte solution. Such a boundary layer could comprise or consist of, for example, a liquid not miscible with the electrolyte solution, such as a polar aprotic solvent. Examples of such liquids include dimethyl sulfoxide and propylene carbonate. As a result, in these embodiments the electrolyte solution is in contact with both the boundary layer and the cathode current collector.

In some embodiments, the electrolyte solution is also in contact with the metal solid (a) of the anode. Alternatively, the electrochemical cell could be designed such that the electrolyte solution is not in contact with the metal solid (a) of the anode.

Contacting any portion of the anode, cathode, or cathode current collector, with electrolyte solution could include placing any or all of them in an electrolyte bath of the solution, and/or completely or partially immersing or submerging any or all of them within a volume of the electrolyte solution. An electrolyte solution could also be directed to flow through, over or between any portions of the anode and cathode, or cathode current collector. An example of flowing a single electrolyte solution through a cell of the disclosure is by flowing the electrolyte solution through a conduit or conduits between the anode and cathode current collector of the cell.

In some embodiments, the cell is configured to operate as a flow cell. The cell may be configured as a flow cell so as to support a flow battery, for example. In a flow configuration, electrolyte solution flows through a cell during its operation. The electrolyte solution could be stored outside of the cell then directed to flow through the cell. Spent electrolyte solution (or one or more electrolyte components) can be recovered as additional electrolyte solution (or one or more electrolyte components) is provided to the cell.

The composition of a single electrolyte solution for any embodiments of the cells of the disclosure may be chosen from a variety of components. The electrolyte solution may comprise a polar solvent. Table 1 lists non-limiting examples of polar solvents for use in the electrolyte solution:

TABLE 1
Polar Solvents

| Solvent | Dielectric constant |
|---|---|
| Water | 80 |
| Sulfuric acid | 101 |
| Ammonia | 26.7 |
| Ethanol | 24.3 |
| Acetonitrile | 36.2 |
| Pyridine | 12.3 |
| Methanol | 30 |
| Glycerol | 47 |
| Ethylene glycol | 37 |
| Hydrofluoric acid | 134 |
| Furfural | 42 |
| Hydrazine | 52 |
| Formamide | 84 |
| Hydrocyanic acid | 158 |

In some embodiments, the electrolyte solution comprises water, one or more alcohols (such as methanol and ethanol), or both water and one or more alcohols as the polar solvent. In other embodiments, the electrolyte solution consists only of water, only of one or more alcohols, or only of a mixture of water and one or more alcohols as the polar solvent. In further embodiments, the electrolyte solution comprises a mixture of water with one or more other polar solvents, including one or more other polar solvents listed in Table 1. The polar solvent may also consist only of water and one or more polar solvents listed in Table 1.

The electrolyte solution can also comprise an oxidant to be reduced in the electrochemical cells as the material of the anode is oxidized. A non-limiting list of compounds in Table 2, or their corresponding salts and acids as the case may be, could be delivered as oxidants and/or dissociate in the polar solvent to form oxidants.

TABLE 2
Oxidants

Peroxydisulfuric acid
Sodium peroxydisulfate
Peroxymonosulfuric acid
Chlorite, chlorate, perchlorate, and other analogous halogen compounds
Hypochlorite and other hypohalite compounds, including NaClO
Hexavalent chromium compounds such as chromic and dichromic acids
and chromium trioxide, pyridinium chlorochromate (PCC), and
chromate/dichromate compounds
Permanganate compounds such as potassium permanganate
Sodium perborate
Sodium bismuthate

As used herein, the term “oxidant” refers to a compound added to perform oxidation as well as the resulting anion that results from dissociation of that compound. Thus, peroxydisulfuric acid (H₂S₂O₈), sodium peroxydisulfate (Na₂S₂O₈) and the peroxydisulfate anion (S₂O₈²⁻) are all oxidants as used herein. When the acid or salt form of the peroxydisulfate oxidant, for example, is added to an electrolyte solution of the disclosure, there will be dissociation into the anion form. The anion form is the form which acts to oxidize another species and which in turn is reduced. Exemplary concentrations of oxidants in the solution include, for example, from 0.25M to 1M, from 0.5M to 1M, from 0.75 to 1M, from 0.5M to 0.75M, from 0.25M to 0.75M, or from 0.25M to 0.5M.

All references to particular oxidants, salts, bases and acids herein, by name or formula, as components of the electrolyte solution include the dissociated forms of those components. As a result, the term peroxydisulfuric acid (or its formula H₂S₂O₈) includes H₂²⁺S₂O₈²⁻, the term sodium peroxydisulfate (or its formula Na₂S₂O₈) includes Na₂²⁺S₂O₈²⁻ and the term sodium hydroxide (or its formula NaOH) includes Na⁺OH⁻.

In some embodiments, the electrolyte solution comprises sodium peroxydisulfate, peroxydisulfuric acid, peroxydisulfate anion (S₂O₈²⁻), or combinations of these. In further embodiments, the electrolyte solution comprises sodium peroxydisulfate, peroxydisulfuric acid, or peroxydisulfate anion (S₂O₈²⁻) in combination with any other oxidant, such as in combination with any other oxidants listed in Table 2 or their respective salts or acids. For example, the electrolyte solution may comprise sodium peroxydisulfate and sodium hypochlorite.

The oxidant can be, for example, in the form of a salt or an acid. Sodium peroxydisulfate is an oxidant and also a salt. Peroxydisulfuric acid is an oxidant and also an acid. Alternatively, if the oxidant is not a salt or an acid, an appropriate salt (such as a metal salt) or acid can be added to the solution with the oxidant to provide components to form an electrolyte solution. In some embodiments, the oxidant is a salt and a second salt is added to or formed in the solution with the oxidant, thereby resulting in the electrolyte solution comprising two salts.

Exemplary salts, such as metal salts, that can be present in the electrolyte solution in addition to an oxidant, are listed in Table 3. All references to “salts” include compounds such as those in Table 3 as well as the dissociated forms of the compounds when in solution.

TABLE 3
Metal Salts

| | | | | | | | |
|---|---|---|---|---|---|---|---|
| KI | NaI | LiI | BaI₂ | CaI₂ | MgI₂ | ZnI₂ | AlI₃ |
| KBr | NaBr | LiBr | BaBr₂ | CaBr₂ | MgBr₂ | ZnBr₂ | AlBr₃ |
| KCl | NaCl | LiCl | BaCl₂ | CaCl₂ | MgCl₂ | ZnCl₂ | AlCl₃ |
| K₂SO₄ | Na₂SO₄ | Li₂SO₄ | BaSO₄ | CaSO₄ | MgSO₄ | ZnSO₄ | Al₂(SO₄)₃ |
| KNO₃ | NaNO₃ | LiNO₃ | Ba(NO₃)₂ | Ca(NO₃)₂ | Mg(NO₃)₂ | Zn(NO₃)₂ | Al(NO₃)₃ |
| KF | NaF | LiF | BaF₂ | CaF₂ | MgF₂ | ZnF₂ | AlF₃ |
| K₃PO₄ | Na₃PO₄ | Li₃PO₄ | Ba₃(PO₄)₂ | Ca₃(PO₄)₃ | Mg₃(PO₄)₂ | Zn₃(PO₄)₂ | AlPO₄ |
| K₂SO₃ | Na₂SO₃ | Li₂SO₃ | BaSO₃ | CaSO₃ | MgSO₃ | ZnSO₃ | Al₂(SO₃)₃ |
| K₂CO₃ | Na₂CO₃ | Li₂CO₃ | BaCO₃ | CaCO₃ | MgCO₃ | ZnCO₃ | Al₂(CO₃)₃ |
| K₂S | Na₂S | Li₂S | BaS | CaS | MgS | ZnS | Al₂S₃ |
| K₂SiO₃ | Na₂SiO₃ | Li₂SiO₃ | BaSiO₃ | CaSiO₃ | MgSiO₃ | ZnSiO₃ | Al₂(SiO₃)₃ |
| KOH | NaOH | LiOH | Ba(OH)₂ | Ca(OH)₂ | Mg(OH)₂ | (Zn(OH)₂ | Al(OH)₃ |

The metal salt should be a compound that dissociates in the polar solvent so as to produce a metal ion and corresponding anion. An example of such a metal salt is aluminum chloride, sodium chloride, aluminum sulfate or sodium sulfate, such as at a concentration of 0.5M in the solution. In embodiments where the solution comprises two salts, such as when the oxidant is a salt and the solution comprises an additional salt such as one listed in Table 3, the salts may comprise either the same or different anion components. The salt may be included in the solution before operating the electrochemical device or may be formed by chemical reaction in the solution during operation of the electrochemical device.

In some embodiments, the electrolyte solution further comprises a base such as a strong base. Examples of strong bases include LiOH, RbOH, CsOH, Sr(OH)₂, Ba(OH)₂, NaOH, KOH, Ca(OH)₂, or combinations thereof. One particular example is NaOH, such as at a concentration of 0.1M to 0.5M, or 2M to 3M in the solution. In other embodiments, the electrolyte solution comprises one or more acids such as nitric acid or sulfuric acid.

The electrolyte solution may therefore comprise, or consist of, for example, a polar solvent and an oxidant. An example polar solvent is water. An example oxidant is a salt of peroxydisulfate (such as sodium peroxydisulfate). Such a solution may further comprise, or consist of, a salt that is different from the oxidant. An example salt is a salt of a sulfate (such as sodium sulfate). A solution that comprises or consists of a polar solvent and oxidant; or of a polar solvent, oxidant, and salt; may further comprise or consist of a base or an acid. Example bases include sodium hydroxide and potassium hydroxide. Example acids include sulfuric acid and nitric acid.

In further embodiments, the electrolyte solution comprises water and the S₂O₈²⁻ or ClO⁻ ion. In such embodiments, the electrolyte solution may comprise one or more of Na₂S₂O₈(aq), H₂S₂O₈(aq) and NaClO(aq).

In still further embodiments, the electrolyte solution comprises an ionic liquid, such as a molten salt having a melting point below 100° C. Exemplary ionic liquids include one or more of aluminum nitrate nonahydrate, aluminum sulfate hydrate (such as aluminum sulfate octahydrate) and sodium aluminum sulfate hydrate. In some embodiments, the ionic liquid comprises aluminum and/or sulfate derivatives. In certain embodiments, it may be advantageous to use an ionic liquid that comprises 2000 ppm or less of water. An electrolyte solution comprising an ionic liquid may further also comprise any additional components described previously as possible components of the electrolyte solution, including the oxidants and metal salts described above, such as Na₂S₂O₈, or S₂O₈²⁻ and/or ClO⁻ ions. In some embodiments, the electrolyte solution could also include a combination of a polar solvent as described above together with an ionic liquid. In other embodiments, the electrolyte solution comprises an ionic liquid but not any polar solvent listed in Table 1 above, or less than 5 weight % or less than 1 weight% of any polar solvent listed in Table 1 above.

In additional embodiments of the disclosure, the electrolyte solution does not comprise sodium hydroxide. In further embodiments, the electrolyte solution does not comprise hydroxides of the Group I (alkali metals) or of the Group II (alkaline earth) metals, and in some embodiments does not comprise any base. Because of its materials of construction, the electrode of the disclosure can develop an oxide layer. Aluminum oxide typically forms in very thin layers on the outside of aluminum, and essentially acts as a barrier to prevent corrosion of the metal. The oxide layer can be disrupted so as to allow the underlying aluminum metal to take part in an electrochemical reaction in the cell. The oxide layer may be disrupted by including a base such as NaOH in the electrolyte solution. In a classic equation 2Al+2NaOH+6H₂O→2NaAl(OH)₄+3H₂, the NaOH first disrupts the oxide layer and then attacks the Al along with water to produce hydrogen gas. When the NaOH attacks the aluminum oxide, it does so indiscriminately and creates small holes in the oxide layer.

It is believed that the liquid phase material (b) disposed on the metal solid comprising aluminum (a) in the electrode of the disclosure can disrupt an oxide layer on the metal solid sufficiently such that the aluminum can take part in the electrochemical reaction. The use of the liquid phase material can thus remove the need for sodium hydroxide in the electrolyte solution. Removing sodium hydroxide, in turn, allows for eliminating the cost and weight of sodium hydroxide in the electrolyte solution, as well as for operating the cell with an electrolyte solution having a lower pH, such as at a pH lower than 14.

The melting point of the liquid phase material will depend in part on the components present in the material. The melting points of gallium and indium have been reported as 29.76° C. and 156.6° C., respectively. A ratio of 78% gallium and 22% indium by weight results in an alloy having a melting point of about 15° C. The addition of tin can lower that melting point to, for example, −19° C.

If the material comprising at least one of gallium and indium is not liquid at the desired operational temperature of the cell, the material can be heated to or above its melting point such that it becomes a liquid. The material can be heated using any appropriate technique. A battery comprising an electrochemical cell of the disclosure will heat itself during charge/discharge and thus the battery itself can be a source of heat. The battery could also or alternatively be exposed to an elevated temperature in a climate-controlled enclosure. As another option, the aluminum metal solid could be directly heated, resulting in a transfer of heat from the aluminum to the material disposed on it. It is also possible to set the electrolyte solution to a certain temperature to effect heat transfer from the electrolyte fluid to the material disposed on the aluminum solid.

In view of the above, it is possible to prepare a cell for use in an electrochemical device, which comprises:
an anode comprising:
   (a) a metal solid comprising aluminum, and
   (b) a solid phase material, comprising at least one of gallium and indium, disposed on the metal solid; and
a cathode, or a cathode current collector, positioned at a distance from the anode.

Such an embodiment may, for example, be constructed, stored or sold in one location where the temperature to which the cell is exposed is lower than the melting point of the material comprising at least one of gallium and indium. Such a cell could then be placed in a higher temperature environment of use in which the solid phase material melts to form a liquid phase material. Just as in other embodiments of the disclosure, the solid phase material could comprise or consist of gallium, indium, or an alloy of gallium and indium, either alone or together with at least one of tin and bismuth. Such a solid phase material (b) may similarly be disposed within the porosity of the metal solid (a), or on the surface of metal solid (a), or both.

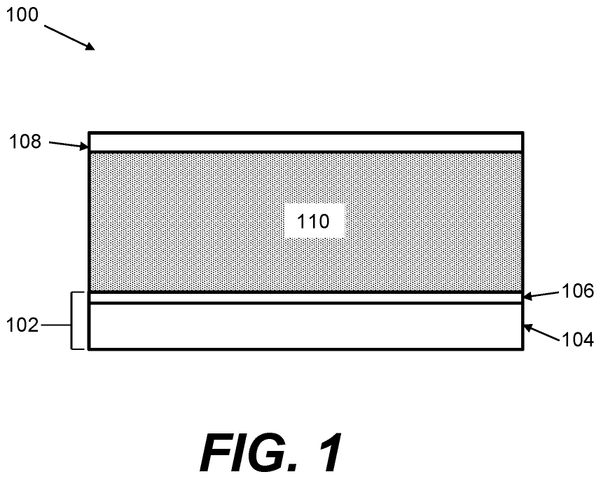

FIG. 1 illustrates a first exemplary embodiment of an electrochemical cell of the disclosure. Electrochemical cell 100 includes anode 102, which comprises metal solid 104 comprising aluminum and a liquid phase material 106 disposed on the metal solid. In FIG. 1, the liquid phase material 106 is shown as having a defined thickness above the surface of the metal solid 104. As an alternative, liquid phase material 106 could be disposed partially or completely within the porosity of metal solid 104. Cathode current collector 108 is positioned at a distance from anode 102. A single electrolyte solution 110, shared between anode 102 and cathode current collector 108, is in contact with the liquid phase material 106 and surface of cathode current collector 108.

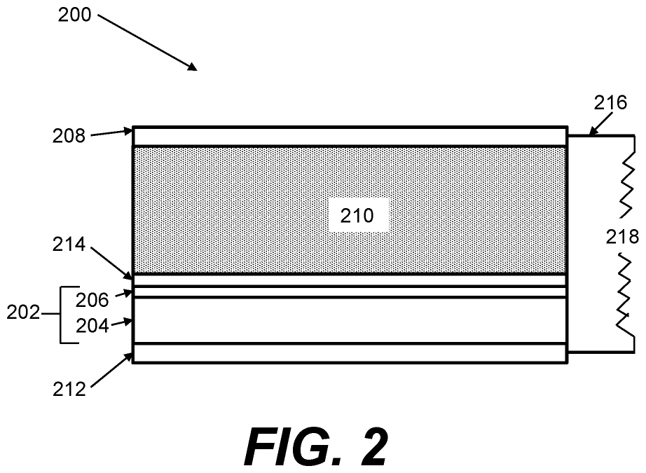

FIG. 2 illustrates a second exemplary embodiment of an electrochemical cell of the disclosure. Electrochemical cell 200 includes anode 202, which comprises metal solid 204 comprising aluminum and a liquid phase material 206 disposed on the metal solid. In FIG. 2, the liquid phase material 206 is shown as having a defined thickness above the surface of the metal solid 204. As an alternative, liquid phase material 206 could be disposed partially or completely within the porosity of metal solid 204. Cathode current collector 208 is positioned at a distance from anode 202. Optional boundary layer 214 is placed between liquid phase material 206 and electrolyte solution 210. Such a boundary layer can in certain embodiments improve performance of the cell and may also serve as a material for aluminum ions to cross. A single electrolyte solution 210, shared between anode 202 and cathode current collector 208, is in contact with optional boundary layer 214 and the surface of the cathode current collector 208. Anode current collector 212 is in contact with metal solid 204 on a side opposite that of liquid phase material 206. Conductive wires 216 from current collectors 208 and 212 connect to load 218.

Electrochemical cells of the disclosure may also be used in otherwise conventional configurations of liquid batteries. In one conventional configuration, a cell includes two half cells and each half cell contains its own electrolyte solution. Oxidation occurs on the anode side of the cell and reduction on the cathode side. Separate aqueous solutions are used on both sides of an electrochemical cell with each side (cathode side and anode side) in contact with an electrode (i.e., the cathode and anode respectively).

A further embodiment of the disclosure therefore includes an electrochemical cell wherein the anode is in contact with a first electrolyte solution; and wherein the cathode or cathode current collector is in contact with a second electrolyte solution. In this embodiment, the first and second electrolyte solutions are separated. The solutions may be separated due to a barrier between them, or because they are immiscible with each other. In one example, such an embodiment comprises a cathode in contact with the second electrolyte solution. In another example, such an embodiment comprises a cathode current collector in contact with the second electrolyte solution, wherein the second electrolyte solution is a catholyte comprising an oxidant.

The electrodes of the two-half cells can then be placed in electrical contact to allow for current to flow. To maintain charge balance, such an electrochemical cell allows for the passage of ions. In some batteries, this is done with a salt bridge separating the cathode solution from the anode solution or by a membrane. Other designs also include membraneless cells where the two aqueous solutions remain separated because they are immiscible.

The electrochemical cells of the disclosure may be used on their own to generate electricity, hydrogen, or both electricity and hydrogen, or may be connected in series and/or in parallel with additional cells of the disclosure such that the assembly of cells is used to generate electricity or hydrogen.

Cells of the disclosure, either alone or in an assembly of more than one cell, may be incorporated into a battery. The terms “battery” and “batteries” when used to describe embodiments of the disclosure is an electrochemical device that can include an individual cell or an assembly of electrochemical cells. The terms “battery and “batteries” can also include a device that comprises one or more additional components, such as associated wiring, a housing or cover that encloses the cells and electrolyte solution, and any other structural components such as terminals and plugs associated with the device, including components added for convenient and safe use of the device by an end user.

An embodiment of the disclosure includes generating hydrogen from an electrochemical cell or battery of the disclosure. Furthermore, when connected to a load, the cells or batteries of the disclosure can produce electricity or both electricity and hydrogen simultaneously. An additional embodiment therefore includes a method of producing electricity, or both electricity and hydrogen, which comprises connecting an electrochemical cell or battery of the disclosure to a load.

The electrochemical cells may be configured such that electricity is primarily delivered, hydrogen is primarily delivered, or both are delivered in various ratios. Variables that can affect the ratio of electricity to hydrogen production include, for example, the number of cells of the disclosure arranged in a series, the surface area of the anode and the composition of the electrolyte solution (such as the amount of water or oxidant in the solution).

Hydrogen production may be controlled by adjusting the specific surface area of the anode as well as temperature. The surface area of the aluminum may be increased, for example, by chemical etching. The hydrogen can then be collected at or from the anode. Advantageously, and unlike with hydrogen production from petroleum products, hydrogen may be created without the liberation of CO₂ or CO.

Electricity can also be controlled by a variety of techniques, such as by adjusting the bulk velocity of the electrolyte solution passing through the cell when in a flow configuration. The cost per useable kWh of energy of direct electricity appears to be less expensive than hydrogen due to differences in consumption of aluminum between the two options. It can therefore be advantageous to tune a cell or battery to favor electricity production over hydrogen production. The use of an ionic liquid in place of an aqueous-based electrolyte solution could also favor electricity production, given that the ionic liquid should have less water, or in some embodiments no water or only very small amounts of water, to react with aluminum and produce hydrogen.

A “load” for purposes of this disclosure is a component, application or other process that consumes electricity. A cell or battery of the disclosure can be connected to a load by placing the load between opposite ends of an electrical circuit, such as illustrated in FIG. 2. The load could also be the resistance in a wire. Example loads include the cell phone towers, electric motors (such as in vehicles), electrical appliances, consumer goods, toys and any other materials, devices or processes that consume electricity. Hydrogen may be delivered to an application such as a fuel cell for electricity production, hydrogen compressors, vehicles, an engine or furnace for burning, or a tank for storage. Embodiments of the disclosure further include methods of delivering hydrogen, or both electricity and hydrogen, produced by the cells or batteries of the disclosure to an application. A further embodiment includes use of an electrode for producing electricity, or both electricity and hydrogen simultaneously, wherein the electrode comprises: (a) a metal solid comprising aluminum, and (b) a liquid phase material, comprising at least one of gallium and indium, disposed on the metal solid.

The electrochemical cells or batteries of the disclosure may be configured to power vehicles (such as electric vehicles or hybrid vehicles). Examples of such vehicles include scooters, motorized grocery cars, forklifts, trucks, passenger cars, golf carts, lift trucks, motorcycles, fork trucks, planes, boats, quads, tractors and other industrial and agricultural vehicles. Hydrogen from the cells and batteries of the disclosure can also be delivered to a fuel cell that generates electricity for a motor for vehicle transport. Electricity may also be used to power a fuel cell controller and/or power other vehicle electronics and/or electric motors of vehicles.

The cells or batteries of the disclosure could also be used as combustion assist devices, such as for diesel assist. This would comprise supplying hydrogen produced by the cells or batteries to an engine to assist in combustion. The supply of hydrogen increases the temperature in the combustion process and should result in more efficient combustion and less particulates formed in the process.

Embodiments of the disclosure include those provided in the following clauses:

Clause 1. A cell for use in an electrochemical device, which comprises:
an anode comprising:
   (a) a metal solid comprising aluminum, and
   (b) a liquid phase material, comprising at least one of gallium and indium, disposed on the metal solid; and
a cathode, or a cathode current collector, positioned at a distance from the anode.

Clause 2. The cell of clause 1, wherein the metal solid (a) further comprises one or more of magnesium, silicon, iron, copper, chromium, zinc, titanium, gallium, indium and manganese.

Clause 3. The cell of any one of clauses 1-2, wherein the metal solid (a) comprises 95% or more aluminum by weight.

Clause 4. The cell of clause 3, wherein the metal solid (a) comprises 99% or more aluminum by weight.

Clause 5. The cell of any one of clauses 1-4, wherein the metal solid (a) is in the form of a sheet, rod, bar, block or foil.

Clause 6. The cell of any one of clauses 1-5, wherein the liquid phase material (b) further comprises at least one of tin and bismuth.

Clause 7. The cell of any one of clauses 1-6, wherein the liquid phase material comprises gallium.

Clause 8. The cell of any one of clauses 1-6, wherein the liquid phase material comprises indium.

Clause 9. The cell of any one of clauses 1-6, wherein the liquid phase material comprises gallium and indium.

Clause 10. The cell of any one of clauses 1-5, wherein the liquid phase material (b) consists of gallium and indium.

Clause 11. The cell of clause 10, wherein the liquid phase material (b) consists of 78% of gallium by weight and 22% of indium by weight.

Clause 12. The cell of any one of clauses 1-11, wherein the metal solid (a) is porous to the liquid phase material (b), and wherein at least a portion of the liquid phase material (b) is disposed within the porosity of the metal solid (a).

Clause 13. The cell of any one of clauses 1-12, wherein the cell comprises a cathode.

Clause 14. The cell of clause 13, wherein the cathode comprises one or more of bronze, phosphor bronze, steel, copper, tin, iron, lead, platinum, gold and silver.

Clause 15. The cell of any one of clauses 1-12, wherein the cell comprises a cathode current collector.

Clause 16. The cell of clause 15, wherein the cathode current collector comprises one or more of bronze, phosphor bronze, steel, carbon, the graphite allotrope of carbon, carbon impregnated with a metal, carbon foam, copper, tin, iron, lead, platinum, gold and silver.

Clause 17. An electrochemical cell comprising:
the cell of any one of clauses 1-16; and
an electrolyte solution.

Clause 18. The electrochemical cell of clause 17, comprising a cathode current collector positioned at a distance from the anode, wherein the electrolyte solution comprises an oxidant and is disposed between the anode and cathode current collector.

Clause 19. The electrochemical cell of clause 18, wherein the electrolyte solution is in contact with both the liquid phase material (b) of the anode and the cathode current collector.

Clause 20. The electrochemical cell of clause 18, which further comprises a boundary layer disposed between the liquid phase material (b) of the anode and the electrolyte solution.

Clause 21. The electrochemical cell of clause 20, wherein the boundary layer is a liquid not miscible with the electrolyte solution.

Clause 22. The electrochemical cell of clause 21, wherein the boundary layer comprises a polar aprotic solvent.

Clause 23. The electrochemical cell of clause 22, wherein the boundary layer comprises at least one of dimethyl sulfoxide and propylene carbonate.

Clause 24. The electrochemical cell of any one of clauses 20-23, wherein the electrolyte solution is in contact with both the boundary layer and the cathode current collector.

Clause 25. The electrochemical cell of any one of clauses 17-24, wherein the electrolyte solution comprises water and the S₂O₈²⁻ or ClO⁻ ion.

Clause 26. The electrochemical cell of clause 25, wherein the electrolyte solution comprises one or more of Na2S2O₈(aq), H₂S₂O₈(aq) and NaClO(aq).

Clause 27. The electrochemical cell of any one of clauses 17-24, wherein the electrolyte solution comprises an ionic liquid.

Clause 28. The electrochemical cell of clause 27, wherein the ionic liquid comprises one or more of aluminum nitrate nonahydrate, aluminum sulfate hydrate and sodium aluminum sulfate hydrate.

Clause 29. The electrochemical cell of clause 27, which comprises 2000 ppm or less water in the electrolyte solution.

Clause 30. The electrochemical cell of any one of clauses 27-29, which comprises the S₂O₈²⁻ or Cl⁻ ion.

Clause 31. The electrochemical cell of any one of clauses 17-30, wherein the electrolyte solution does not comprise Na⁺OH⁻.

Clause 32. The electrochemical cell of clause 17, wherein the anode is in contact with a first electrolyte solution; and wherein the cathode or cathode current collector is in contact with a second electrolyte solution.

Clause 33. The electrochemical cell of clause 32, which comprises a cathode in contact with the second electrolyte solution.

Clause 34. The electrochemical cell of clause 32, which comprises a cathode current collector in contact with the second electrolyte solution, wherein the second electrolyte solution comprises an oxidant.

Clause 35. A method of producing electricity, which comprises connecting the electrochemical cell of any one of clauses 17-34 to a load.

Clause 36. The method of clause 35, wherein the load is a cell phone tower, an electric motor, an electrical appliance, a consumer good or a toy.

Clause 37. Use of an electrode for producing electricity, wherein the electrode comprises:
(a) a metal solid comprising aluminum, and
(b) a liquid phase material, comprising at least one of gallium and indium, disposed on the metal solid.

Clause 38. A cell for use in an electrochemical device, which comprises:
an anode comprising:
   (a) a metal solid comprising aluminum, and
   (b) a solid phase material, comprising at least one of gallium and indium, disposed on the metal solid; and
a cathode, or a cathode current collector, positioned at a distance from the anode.

Clause 39. A cell of clause 38, wherein the solid phase material comprises gallium.

Clause 40. A cell of clause 38, wherein the solid phase material comprises indium.

Clause 41. A cell of clause 38, wherein the solid phase material comprises gallium and indium.

### EXAMPLE 1

A sample of aluminum-containing metal was submerged within a volume of liquid alloy of gallium and indium according to the disclosure. Submersion of the metal in the liquid alloy prevented or reduced oxidation of the metal sample. After removing the metal sample from the alloy, the metal reacted with air and formed oxide continuously.

### EXAMPLE 2

A first electrochemical cell of the disclosure was made. The cell used a single electrolyte solution shared between the anode (metal solid with liquid alloy of gallium and indium) and a cathode current collector. The electrolyte solution contained sodium persulfate dissolved in water and the cathode current collector was carbon foam. The cell yielded electricity production of 2V open circuit and 0.5 W at 2Ω load resistance. A further run of the experiment yielded 2.25V open circuit.

### EXAMPLE 3

A second electrochemical cell of the disclosure was made. The cell used a single electrolyte solution shared between the anode (metal solid with liquid alloy of gallium and indium) and a cathode current collector. The electrolyte solution contained sodium hypochlorite dissolved in water and the cathode current collector was carbon foam. The cell yielded electricity production of 1.7V open circuit at 0.3 W max power.

### EXAMPLE 4

A third electrochemical cell of the disclosure was made. The cell used an ionic liquid, in place of an aqueous-based electrolyte solution, shared between the anode (metal solid with liquid alloy of gallium and indium) and a cathode current collector. 60 g of aluminum nitrate nonahydrate (Al(NO₃)₃*9H₂O) was heated in a double boiler. An aluminum-based salt such as this can be advantageous due to its contribution of aluminum ions. Once the salt was molten at 73.9° C., 60 g of sodium persulfate was added. The cathode current collector was carbon foam. Electricity output was 2.60V open circuit, at 0.06 W and 4.3Ω load resistance. The higher voltage, compared to Examples 2 and 3, is believed to be due to the reduced amount of water in the electrolyte solution.

### EXAMPLE 5: Aqueous Alloy Experiment

The following battery chemistry selected for this experiment was an aqueous 60° C., 0.75M Na₂S₂O₈ battery solution. The aluminum/alloy anode mass at the beginning of the experiment and the end of the experiment were both recorded, and aluminum/alloy mass loss calculated as the difference between the initial and final measurements. All anode mass loss was assumed to be aluminum mass loss. A single battery cell was constructed with an aluminum/alloy anode, two opposing carbon felt cathode current collectors, a plastic ABS 3D printed electrode scaffold, and a glass beaker containing approximately 200 mL of battery solution with a magnetic stir bar to induce fluid flow in the system. The beaker was placed in a controlled water bath to maintain the desired temperature of 60±1° C. throughout the experiment.

The aluminum/alloy anode was manufactured by placing a 34.5 g aluminum sample into a gallium/indium alloy mixture. The gallium/indium mixture roughly comprised 76.6% gallium and 23.4% indium by atomic percentages. This atomic ratio creates a liquid at room temperature, and other ratios may be more optimal for electricity and/or hydrogen production. The aluminum sample was submerged in the gallium/indium alloy for roughly 5 days, at which point the sample was removed and excess gallium/indium was removed from the surface of the aluminum. After the gallium/indium mixture penetrated the aluminum sample, the anode weighed 37.88 g. This equates to approximately a 3.38 g mass gain from gallium/indium absorption. Overall, this created a sample with an approximate atomic ratio of 1 Al:34 Ga:185 In.

A Keithley Model 2461 Source Measure Unit (SMU) measured the electrical energy generated from the battery. The SMU utilized Kelvin (four-wire) measurement to compensate for supplemental line resistance and provided accurate voltage and current measurements. Voltage and current measurements were later used for power (Watts) and energy (Watt Hours) calculations. The SMU sunk a constant 500 mA, 22.96 mA/cm² normalized anode current, and recorded the voltage output of the battery over the duration of the experiment. A voltage cutoff of 0.100V was specified for all experimental trials. Experimental results were processed via a mechanistic model. Computed parameters included specific energy, energy distribution between hydrogen and electricity, electricity and hydrogen production per square centimeter, and other parameters.

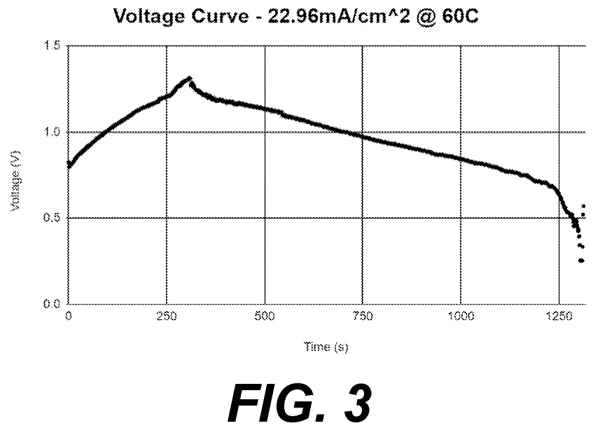

The electrode apparatus was introduced into the aqueous 0.75M Na₂S₂O₈ battery solution at 60° C. The battery voltage initially increased to a maximum of 1.311V before voltage declined over time as seen in FIG. 3. Sodium persulfate concentration declined over time, which in turn caused a battery voltage decline. Cycle, voltage, and time data were imported into the mechanistic model from the SMU with voltage over time graphed in FIG. 3.

The experiment lasted 1,312.43 seconds from start to the end of the third depletion at a constant 500 mA current draw.

Table 4 presents the measured or calculated results of this experiment. The percentage of energy derived from hydrogen was 99.55%, and the percentage of direct electricity was 0.45%. Hydrogen generated from this battery could be consumed by a hydrogen fuel cell to generate electricity. The specific energy and energy density will change based on the efficiency of the fuel cell. In this context, calculated values of energy density and specific energy, based on a 60% efficiency hydrogen fuel cell, are also provided in Table 4. Future efficiency gains in hydrogen fuel cells could further increase the realized specific energy and energy density of the application.

TABLE 4

| | | | |
|---|---|---|---|
| | | Temperature: | 60 C. |
| ED Incl. H2 (Wh/L) | 162.139 | Current (A): | 0.500 |
| ED Incl. H2 HHV 60% | 115.231 | Electrical Energy (Wh) | 0.176 |
| FC (Wh/L) | | | |
| | | Specific Energy (Wh/kg) | 4.329 |
| | | SE Incl. H2 LHV (Wh/kg) | 541.314 |
| | | SE Incl. H2 FC 60% HHV | 384.706 |
| | | (Wh/kg) | |

ED = energy density
SE = specific energy
LHV = lower heating value
HHV = higher heating value
FC = fuel cell

1. A cell for use in an electrochemical device, which comprises:
an anode comprising:
(a) a metal solid comprising aluminum, and
(b) a liquid phase material, comprising at least one of gallium and indium, disposed on the metal solid; and
a cathode, or a cathode current collector, positioned at a distance from the anode.

2. The cell of claim 1, wherein the metal solid (a) further comprises one or more of magnesium, silicon, iron, copper, chromium, zinc, titanium, gallium, indium and manganese.

3. (canceled)

4. The cell of claim 1, wherein the metal solid (a) comprises 99% or more aluminum by weight.

5. (canceled)

6. The cell of claim 1, wherein the liquid phase material (b) further comprises at least one of tin and bismuth.

7-8. (canceled)

9. The cell of claim 1, wherein the liquid phase material comprises gallium and indium.

10. (canceled)

11. The cell of claim 1, wherein the liquid phase material (b) consists of 78% of gallium by weight and 22% of indium by weight.

12. The cell of claim 1, wherein the metal solid (a) is porous to the liquid phase material (b), and wherein at least a portion of the liquid phase material (b) is disposed within the porosity of the metal solid (a).

13-14. (canceled)

15. The cell of claim 1, wherein the cell comprises a cathode current collector.

16. The cell of claim 15, wherein the cathode current collector comprises one or more of bronze, phosphor bronze, steel, carbon, the graphite allotrope of carbon, carbon impregnated with a metal, carbon foam, copper, tin, iron, lead, platinum, gold and silver.

17. An electrochemical cell comprising:
the cell of claim 1; and
an electrolyte solution.

18. The electrochemical cell of claim 17, comprising a cathode current collector positioned at a distance from the anode, wherein the electrolyte solution comprises an oxidant and is disposed between the anode and cathode current collector.

19. (canceled)

20. The electrochemical cell of claim 18, which further comprises a boundary layer disposed between the liquid phase material (b) of the anode and the electrolyte solution.

21. (canceled)

22. The electrochemical cell of claim 20, wherein the boundary layer comprises a polar aprotic solvent.

23-25. (canceled)

26. The electrochemical cell of claim 17, wherein the electrolyte solution comprises one or more of Na₂S₂O₈(aq), H₂S₂O₈(aq) and NaClO(aq).

27. The electrochemical cell of claim 17, wherein the electrolyte solution comprises an ionic liquid.

28. The electrochemical cell of claim 27, wherein the ionic liquid comprises one or more of aluminum nitrate nonahydrate, aluminum sulfate hydrate and sodium aluminum sulfate hydrate.

29. The electrochemical cell of claim 27, which comprises 2000 ppm or less water in the electrolyte solution.

30. (canceled)

31. The electrochemical cell of claim 17, wherein the electrolyte solution does not comprise Na⁺OH⁻.

32-34. (canceled)

35. A method of producing electricity, which comprises connecting the electrochemical cell of claim 17 to a load.

36-37. (canceled)

38. A cell for use in an electrochemical device, which comprises:
an anode comprising:
(a) a metal solid comprising aluminum, and (b) a solid phase material, comprising at least one of gallium and indium, disposed on the metal solid; and
a cathode, or a cathode current collector, positioned at a distance from the anode.

39-41. (canceled)
